(19) United States
(12) Patent Application Publication
(10) Pub. No.: US 2021/0184486 A1
(43) Pub. Date: Jun. 17, 2021

(54) PRE-CHARGING CIRCUIT AND PRE-CHARGING METHOD

(71) Applicant: CONTEMPORARY AMPEREX TECHNOLOGY CO., LIMITED, Ningde (CN)

(72) Inventors: Zhimin Dan, Ningde (CN); Jinbo Cai, Ningde (CN); Meilin Chen, Ningde (CN); Yizhen Hou, Ningde (CN); Wei Zhang, Ningde (CN)

(21) Appl. No.: 17/123,022

(22) Filed: Dec. 15, 2020

Related U.S. Application Data
(63) Continuation of application No. PCT/CN2019/124957, filed on Dec. 12, 2019.

(51) Int. Cl. H02J 7/00; H02J 7/34

(52) U.S. Cl. CPC H02J 7/00711; H02J 7/345; H02J 7/0063

(57) ABSTRACT

This application relates to a pre-charging circuit and a method thereof. The pre-charging circuit includes a controller, a PWM control unit, and a drive unit. The controller and the PWM control unit are electrically connected to the drive unit, and the drive unit is connected to a main switch of a battery management system circuit. When the main switch is turned on, the PWM control unit detects a current in the battery management system circuit and outputs a control signal to the drive unit according to the current. The controller outputs a preset PWM signal to the drive unit, which then turns the main switch off or on according to the received control signal and the PWM signal, to pre-charge a load capacitor of the battery management system circuit when the main switch (S1) is turned on, thereby implementing fast pre-charging by adjusting a pre-charging time of the load capacitor.

### CROSS-REFERENCE TO RELATED APPLICATIONS

This application is a continuation application of PCT Patent Application No. PCT/CN2019/124957, entitled “PRE-CHARGING CIRCUIT AND PRE-CHARGING METHOD” filed on Dec. 12, 2019, which claims priority to Chinese Patent Application No. 201811474762.X, filed with the State Intellectual Property Office of the People's Republic of China on Dec. 4, 2018, and entitled “PRE-CHARGING CIRCUIT AND PRE-CHARGING METHOD”, all of which are incorporated herein by reference in their entirety.

### TECHNICAL FIELD

Embodiments of this application relate to the technical field of circuitry, and in particular, to a pre-charging circuit and a pre-charging method.

### BACKGROUND

In a battery management system of a new energy vehicle, in a case that a capacitance value of a battery load is relatively large, a circuit current will rise rapidly at the instant of turning on a main relay. To reduce an instantaneous current at the time of turning on the main relay, a prevalent handling method currently available is to pre-charge a main circuit with a pre-charging circuit before the main relay is turned on, so as to reduce a voltage difference between a battery and the load capacitor at the time of turning on the main relay, thus reduce the instantaneous current at the time of turning on the main circuit, and thus reduce a failure rate of the main relay and improve circuit performance.

It is found that the prior art includes at least the following problems: The pre-charging circuit in the battery management system generally includes a large quantity of current limiting resistors, and a pre-charging time is long. In addition, the large quantity of current limiting resistors occupy a large part of the area of a printed circuit board assembly (PCBA). A thermal power consumption of the current limiting resistors is large. A PCBA with a current limiting resistor needs special heat dissipation treatment. A housing of the PCBA with a current limiting resistor needs to have an extra space for mounting a thermal pad to allow dissipation of heat of the current limiting resistors through the housing, thereby increasing costs.

### SUMMARY

An objective of embodiments of this application is to disclose a pre-charging circuit and a pre-charging method to adjust a pre-charging time of a load capacitor of a battery management circuit according to needs.

To solve the above technical problems, an embodiment of this application discloses a pre-charging circuit, including: a controller, a PWM control unit, and a drive unit. The controller and the PWM control unit are connected to the drive unit, and the drive unit is connected to a main switch of a battery management system circuit. The PWM control unit is configured to detect a current existent in the battery management system circuit when the main switch is turned on. The PWM control unit is further configured to output a control signal to the drive unit according to the current. The controller is configured to output a preset PWM signal to the drive unit. The drive unit is configured to turn the main switch off or on according to the received control signal and PWM signal, so as to pre-charge a load capacitor of the battery management system circuit when the main switch is turned on.

An embodiment of this application further discloses a pre-charging method, applied to a pre-charging circuit. The pre-charging circuit includes a controller, a PWM control unit, and a drive unit. The controller and the PWM control unit are connected to the drive unit, and the drive unit is connected to a main switch of a battery management system circuit. The method includes: detecting, by the PWM control unit, a current existent in the battery management system circuit when the main switch is turned on, and outputting, by the PWM control unit, a control signal to the drive unit according to the current; outputting, by the controller, a preset PWM signal to the drive unit; and turning, by the drive unit, the main switch off or on according to the received control signal and PWM signal, so as to pre-charge a load capacitor of the battery management system circuit when the main switch is turned on.

In contrast with the prior art, in the embodiments of this application, the PWM control unit can detect the current existent in the battery management system circuit when the main switch of the battery management system circuit is turned on, and output the control signal to the drive unit according to the current. The controller outputs the preset PWM signal to the drive unit. According to the received control signal and PWM signal, the drive unit turns the main switch off or on. When the main switch is turned on, the load capacitor of the battery management system circuit can be pre-charged. In this application, the PWM control unit outputs the control signal to the drive unit, and the controller outputs the PWM signal to the drive unit, so that the drive unit can control on and off states of the main switch according to the control signal and the PWM signal to implement the pre-charging of the load capacitor. Compared with the conventional pre-charging circuit, this application reduces costs. In addition, the PWM signal output by the controller is used to adjust the pre-charging time of the load capacitor, so that the pre-charging time of the load capacitor of the battery management circuit can be adjusted according to needs, so as to achieve fast pre-charging.

In addition, the PWM control unit is specifically configured to output a low level control signal to the drive unit when the current is greater than a preset current threshold, and stop output of the low level control signal to the drive unit when the current is less than or equal to the preset current threshold. The drive unit is specifically configured to control, when the low level control signal and the PWM signal are received, the main switch to turn off, and control, when the low level control signal is not received and the PWM signal is at a high level, the main switch to turn on to pre-charge the load capacitor of the battery management system circuit. In this embodiment, if the current in the battery management system circuit is greater than the preset current threshold when the main switch is turned on, the PWM control unit outputs a low level control signal to the drive unit, and the controller outputs the PWM signal to the drive unit. At this time, a signal coupled to the drive unit is 0, and the drive unit controls the main switch to turn off. When the current is less than or equal to the current threshold, the PWM control unit stops outputting the low level control signal to the drive unit, and the controller outputs the PWM signal to the drive unit. At this time, the PWM signal controls the on and off states of the main switch. When the PWM signal is at a high level, the drive unit controls the main switch to turn on to implement pre-charging of the load capacitor, thereby pre-charging the load capacitor while protecting the battery management system circuit.

In addition, the PWM control unit includes a sampling unit, a PWM output unit, and a semiconductor switch that are connected in sequence, and the semiconductor switch is connected to the drive unit. The sampling unit is configured to detect a current existent in the battery management system circuit when the main switch is turned on. The PWM output unit is configured to output a low level control signal to the drive unit through the semiconductor switch when the current is greater than the preset current threshold, and stop output of the low level control signal to the drive unit through the semiconductor switch when the current is less than or equal to the preset current threshold. This embodiment discloses a specific implementation of a PWM control unit.

In addition, the pre-charging circuit further includes a high-voltage sampling unit connected to the PWM control unit and the controller. The high-voltage sampling unit is configured to detect a voltage across the load capacitor. The PWM control unit is further configured to stop output of the control signal to the drive unit when the voltage across the load capacitor reaches a preset voltage threshold. The controller is configured to stop output of the PWM signal when the voltage across the load capacitor reaches the preset voltage threshold, and output a high level electrical signal to the drive unit. In this embodiment, the voltage across the load capacitor is detected by the high-voltage sampling unit, so as to control the battery management system circuit to start normal work when the voltage across the load capacitor reaches the preset voltage threshold.

In addition, the sampling unit is specifically configured to collect a voltage across a current divider in the battery management system circuit, and calculate the current according to a resistance value of the current divider and the voltage across the current divider. This embodiment discloses a specific implementation of detecting the current in the battery management system circuit when the sampling unit detects an on state of the main switch.

In addition, the PWM output unit is specifically configured to output, when the current is greater than a preset current threshold, a high level electrical signal to turn on the semiconductor switch, so as to output the low level control signal to the drive unit. The PWM output unit is specifically configured to output, when the current is less than or equal to the preset current threshold, a low level electrical signal to turn off the semiconductor switch, so as to stop output of the low level control signal to the drive unit.

In addition, the main switch is a semiconductor power switch. In this embodiment, the semiconductor power switch is used as a main switch, thereby reducing the failure rate of the main switch.

In addition, the semiconductor power switch is an insulated gate bipolar transistor (IGBT) or a metal oxide semiconductor field effect transistor (MOSFET). This embodiment discloses the specific type of the semiconductor power switch.

### DESCRIPTION OF DRAWINGS

One or more embodiments are described exemplarily with reference to accompanying drawings corresponding to the embodiments. The exemplary description shall not constitute any limitation on the embodiments. Components labeled with the same reference numeral in the accompanying drawings represent similar components. Unless otherwise specified, the accompanying drawings are not subject to a scale limitation.

FIG. 1 is a structural diagram of a battery management system circuit according to a first embodiment of this application;

FIG. 2 is a schematic block diagram of a pre-charging circuit according to a first embodiment of this application;

FIG. 3 is a schematic block diagram of a pre-charging circuit according to a third embodiment of this application;

FIG. 4 is a structural diagram of a battery management system circuit according to a third embodiment of this application;

FIG. 5 is a schematic diagram of a pulse-width modulation (PWM) signal according to a third embodiment of this application;

FIG. 6 is a schematic diagram of a signal coupled to an input (IN) end of a drive unit according to a third embodiment of this application;

FIG. 7 is a schematic block diagram of a pre-charging circuit according to a fourth embodiment of this application;

FIG. 8 is a specific flowchart of a pre-charging method according to a fifth embodiment of this application;

FIG. 9 is a specific flowchart of a pre-charging method according to a sixth embodiment of this application;

FIG. 10 is a specific flowchart of a pre-charging method according to a seventh embodiment of this application; and

FIGS. 11A and 11B are a specific flowchart of a pre-charging method according to an eighth embodiment of this application.

### DESCRIPTION OF EMBODIMENTS

To make the objectives, technical solutions, and advantages of this application clearer, the following describes the embodiments of this application in detail with reference to accompanying drawings. A person of ordinary skill in the art understands that in each embodiment of this application, many technical details are provided to make readers better understand this application. However, the technical solutions claimed in this application can still be implemented even without the technical details and without making variations and modifications based on the following embodiments.

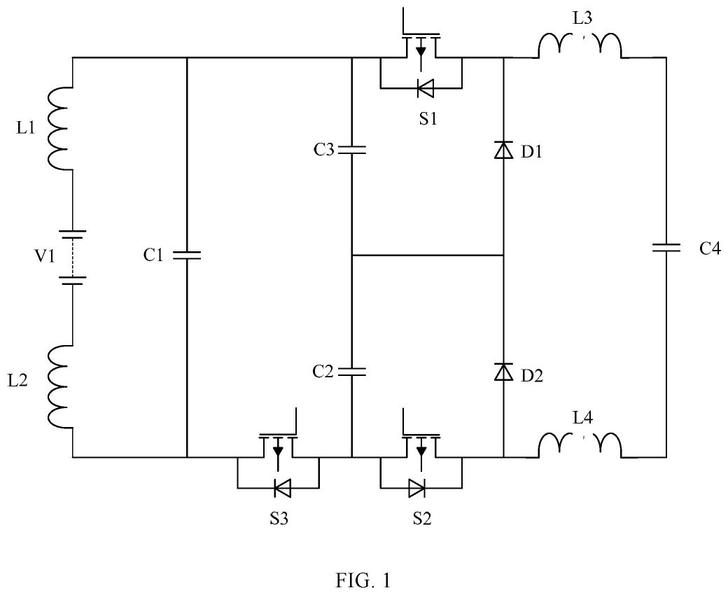

A first embodiment of this application relates to a pre-charging circuit configured to pre-charge a load capacitor in a battery management system circuit. As shown in FIG. 1, the battery management system circuit includes a battery pack V1, parasitic inductors L1 to L4, a positive main switch S1, a negative main switch S2, an anti-reverse switch S3, an X capacitor C1, protective capacitors C2 and C3, freewheeling diodes D1 and D2, and a load capacitor C4.

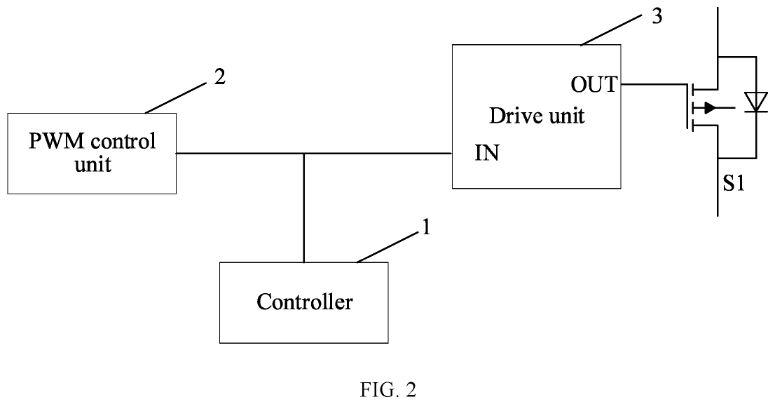

Referring to FIG. 2, the pre-charging circuit includes: a controller 1, a PWM control unit 2, and a drive unit 3. The controller 1 and the PWM control unit 2 are connected to the drive unit 3. The drive unit 3 is connected to a main switch of the battery management system circuit. The main switch may be the positive main switch S1 or the negative main switch S2. In this embodiment and subsequent embodiments, an example is described in which the main switch is the positive main switch S1. In an example, the main switch is a semiconductor power switch, thereby reducing a failure rate of the main switch. The semiconductor power switch may be an IGBT or a MOSFET.

The PWM control unit 2 is configured to detect a current existent in the battery management system circuit when the main switch is turned on, and output a control signal to the drive unit 3 according to the current.

The controller 1 is configured to output a preset PWM signal to the drive unit 3. The PWM signal may be a signal with a fixed pulse width or a signal with a gradually varying pulse width.

The drive unit 3 is configured to control, according to the received control signal and PWM signal, the main switch of the battery management system circuit to turn off or on. Specifically, by outputting a control signal at an output (OUT) end, the drive unit 3 controls, according to the control signal and the PWM signal that are coupled to an IN end of the drive unit, the main switch to turn off or on, so as to pre-charge the load capacitor C4 of the battery management system circuit when the main switch is turned on.

It needs to be noted that the controller 1 is also connected to the negative main switch S2 and the anti-reverse switch S3. Before pre-charging the load capacitor C4, the controller 1 outputs a continuous high level signal to the negative main switch S2 and the anti-reverse switch S3, so as to turn on the negative main switch S2 and the anti-reverse switch S3. In addition, if the negative main switch S2 is used as a main switch, the controller 1 outputs a continuous high level signal to the positive main switch S1 and the anti-reverse switch S3 before pre-charging the load capacitor C4, so as to turn on the positive main switch S1 and the anti-reverse switch S3.

In contrast with the prior art, in this embodiment, the PWM control unit can detect the current existent in the battery management system circuit when the main switch of the battery management system circuit is turned on, and output the control signal to the drive unit according to the current. The controller outputs the preset PWM signal to the drive unit. According to the received control signal and PWM signal, the drive unit turns the main switch off or on. When the main switch is turned on, the load capacitor of the battery management system circuit can be pre-charged. In this application, the PWM control unit outputs the control signal to the drive unit, and the controller outputs the PWM signal to the drive unit, so that the drive unit can control on and off states of the main switch according to the control signal and the PWM signal to implement the pre-charging of the load capacitor. Compared with the conventional pre-charging circuit, this application reduces costs. In addition, the PWM signal output by the controller is used to adjust the pre-charging time of the load capacitor, so that the pre-charging time of the load capacitor of the battery management circuit can be adjusted according to needs, so as to achieve fast pre-charging.

A second embodiment of this application relates to a pre-charging circuit. This embodiment is substantially the same as the first embodiment, and primarily differs in: this embodiment discloses a specific implementation of a controller 1, a PWM control unit 2, and a drive unit 3.

Referring to FIG. 1 and FIG. 2, the PWM control unit 2 is specifically configured to output a low level control signal to the drive unit 3 when the current is greater than a preset current threshold, and stop output of the low level control signal to the drive unit 3 when the current is less than or equal to the preset current threshold.

The controller 1 is specifically configured to output a high level PWM signal to the drive unit when the current is greater than a preset current threshold, and output a PWM signal with a tunable pulse width to the drive unit when the current is less than or equal to the current threshold.

The drive unit 3 is specifically configured to control, when the low level control signal and the PWM signal are received, the main switch to turn off, and control, when the low level control signal is not received and the PWM signal is at a high level, the main switch to turn on to pre-charge the load capacitor of the battery management system circuit.

Specifically, in a case of a zero-state response, when the main switch in the battery management system circuit is turned on, a large instantaneous current is generated in the battery management system circuit. The battery management system circuit has a safe current value (that is, a preset current threshold).

If the PWM control unit 2 detects that the current in the battery management system circuit is greater than the preset current threshold when the main switch is turned on, the PWM control unit 2 outputs a low level control signal to the drive unit 3, and the controller 1 outputs the PWM signal to the drive unit 3. At this time, the PWM signal output by the controller 1 to the drive unit 3 is degraded by the low level control signal, the signal coupled to the IN end of the drive unit 3 is 0, the drive unit 3 controls the main switch to turn off, and the load capacitor C4 of the battery management system circuit is not pre-charged.

If the PWM control unit 2 detects that the current in the battery management system circuit is less than or equal to the preset current threshold when the main switch is turned on, the PWM control unit 2 stops outputting the low level control signal to the drive unit 3, and the controller 1 outputs the PWM signal to the drive unit 3. At this time, the input of the drive unit 3 is determined only by the PWM signal output by the controller 1. When the PWM signal is at a high level, the drive unit 3 controls the main switch to turn on to pre-charge the load capacitor C4 of the battery management system circuit. When the signal is at a low level, the drive unit 3 controls the main switch to turn off to stop pre-charging the load capacitor C4. When a next high level of the PWM signal comes, the above processes are repeated.

In contrast with the first embodiment, in this embodiment, if the current in the battery management system circuit is greater than the preset current threshold when the main switch is turned on, the PWM control unit outputs a low level control signal to the drive unit, and the controller outputs the PWM signal to the drive unit. At this time, a signal coupled to the drive unit is 0, and the drive unit controls the main switch to turn off. When the current is less than or equal to the current threshold, the PWM control unit stops outputting the low level control signal to the drive unit, and the controller outputs the PWM signal to the drive unit. At this time, the PWM signal controls the on and off states of the main switch. When the PWM signal is at a high level, the drive unit controls the main switch to turn on to implement pre-charging of the load capacitor, thereby pre-charging the load capacitor while protecting the battery management system circuit.

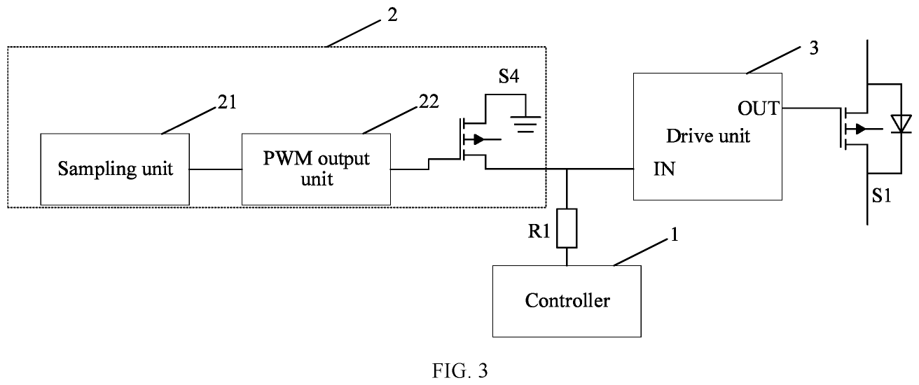

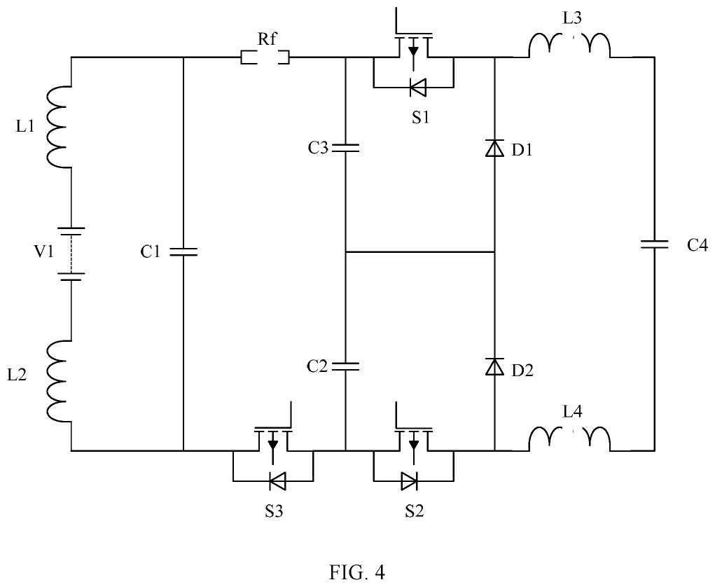

A third embodiment of this application relates to a pre-charging circuit. This embodiment is substantially the same as the second embodiment, and primarily differs in: In this embodiment, referring to FIG. 3 and FIG. 4, the PWM control unit 2 includes a sampling unit 21, a PWM output unit 22, and a semiconductor switch S4 that are connected in sequence.

The sampling unit 21 is configured to detect a current existent in the battery management system circuit when the main switch is turned on. Specifically, the sampling unit 21 can collect a voltage across a current divider Rf in the battery management system circuit, and calculate, according to a resistance value of the current divider Rf and the voltage across the current divider Rf, the current existent in the battery management system circuit when the main switch is turned on.

The PWM output unit 22 is configured to output a low level control signal to the drive unit 3 through the semiconductor switch S4 when the current is greater than the preset current threshold, and stop output of the low level control signal to the drive unit 3 through the semiconductor switch S4 when the current is less than or equal to the preset current threshold.

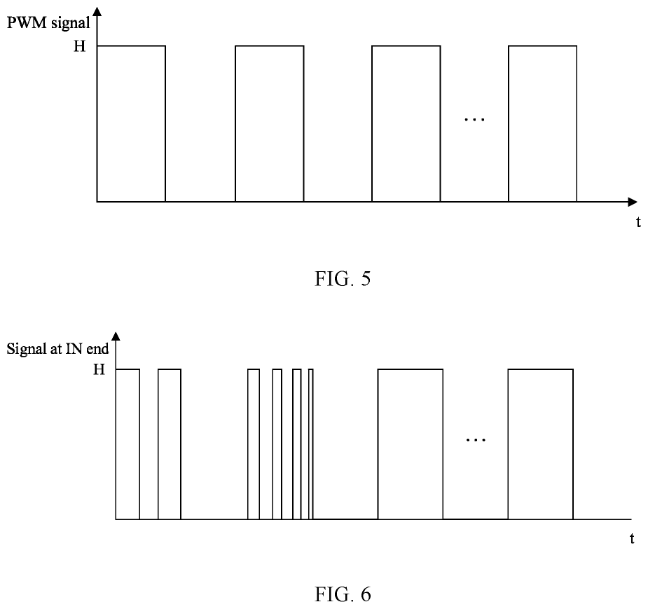

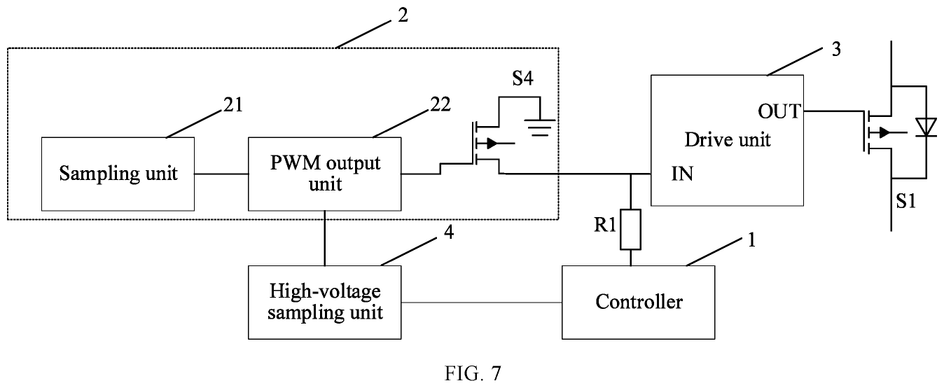

Specifically, during the pre-charging process, the controller 1 outputs a preset PWM signal to the drive unit, and a current limiting resistor R1 is generally serially connected between the controller 1 and the drive unit 3. The sampling unit 21 detects the current existent in the battery management system circuit when the main switch is turned on. If the current in the battery management system circuit is greater than the preset current threshold when the main switch is turned on, the PWM output unit 22 outputs a high level electrical signal to the semiconductor switch S4, and the semiconductor switch S4 is turned on to output a low level control signal to the drive unit 3. At this time, the PWM signal output by the controller 1 to the drive unit 3 is degraded by the low level control signal, the signal coupled to the IN end of the drive unit 3 is 0, the drive unit 3 controls the main switch to turn off, and the load capacitor C4 of the battery management system circuit is not pre-charged. If the current in the battery management system circuit is less than or equal to the preset current threshold when the main switch is turned on, the PWM output unit 22 outputs a low level electrical signal to the semiconductor switch S4, and the semiconductor switch S4 is cut off to stop outputting the low level control signal to the drive unit 3. At this time, the input of the drive unit 3 is determined only by the PWM signal output by the controller 1. When the PWM signal is at a high level, the drive unit 3 controls the main switch to turn on to pre-charge the load capacitor C4 of the battery management system circuit. When the signal is at a low level, the drive unit 3 controls the main switch to turn off to stop pre-charging the load capacitor C4. When a next high level of the PWM signal comes, the above processes are repeated. As shown in FIG. 5 and FIG. 6, FIG. 5 shows a PWM signal with a fixed pulse width, and FIG. 6 shows a signal coupled to an IN end of the drive unit 3.

In contrast with the second embodiment, this embodiment discloses a specific implementation of a PWM control unit.

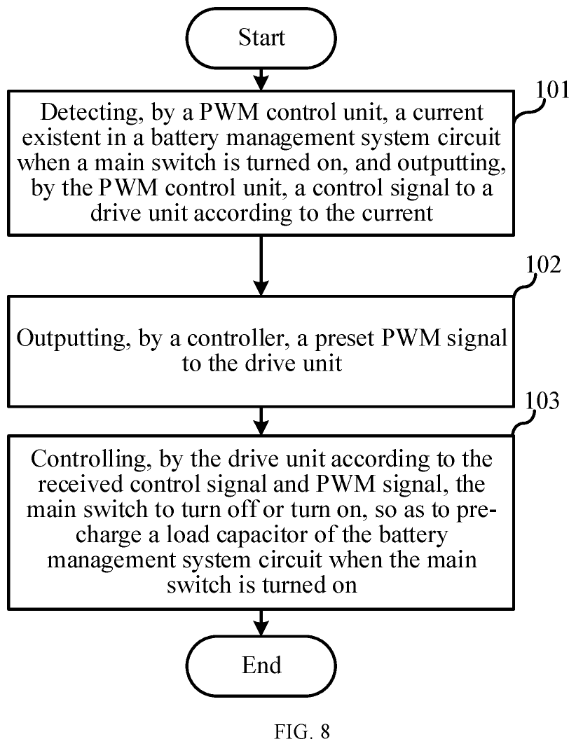

A fourth embodiment of this application relates to a pre-charging circuit. The fourth embodiment is an improvement based on the third embodiment. The improvement primarily lies in: referring to FIG. 7, the pre-charging circuit further includes a high-voltage sampling unit 4 connected to the PWM control unit 2 and the controller 1. Specifically, the high-voltage sampling unit 4 is connected to the PWM output unit 22 of the PWM control unit 2.

In this embodiment, the high-voltage sampling unit 4 is configured to detect a voltage across the load capacitor C4.

During the pre-charging process of the load capacitor C4, the voltage across the load capacitor C4 gradually increases, the instantaneous current generated by the battery management system circuit when the main switch is turned on gradually decreases, and the voltage across the load capacitor C4 is an instantaneous voltage value existent before the main switch is turned off. During the pre-charging process of the load capacitor C4, the voltage across the load capacitor C4 changes to

$${U}_{C 4} = {U}_{V 1} \times ( 1 - {e}^{- \frac{t}{τ}} ) ,$$

and the current of the battery management system circuit changes to

$$I = \frac{{U}_{V 1}}{R} \times {e}^{- \frac{t}{τ}} ,$$

where τ=R×C, UV1 denotes a voltage of the battery pack V1, R is an equivalent impedance of the battery management system circuit, C is a capacitance value of the load capacitor C4, and t denotes a pre-charging time.

During the pre-charging process of the load capacitor C4, if the voltage UC4 across the load capacitor C4 reaches the preset voltage threshold, the pre-charging of the load capacitor C4 is completed, and the PWM output unit 22 of the PWM control unit 2 stops, through the semiconductor switch S4, outputting the low level control signal to the drive unit 3, and the controller 1 stops outputting the PWM signal and outputs a high level electrical signal to the drive unit 3. At this time, the drive unit 3 only receives the high level electrical signal output by the controller 1, the main switch is turned on, and the battery management system circuit starts to work normally. The voltage threshold is, for example, 95% of the voltage UV1 of the battery pack V1. That is, when it is detected that the voltage across the load capacitor C4 reaches 95% of the battery voltage UV1, the pre-charging for the load capacitor C4 stops.

It needs to be noted that this embodiment is described by using an example in which the high-voltage sampling unit 4 is a stand-alone unit. However, without being limited to this, the high-voltage sampling unit 4 may be a part of the PWM control unit 2.

In contrast with the third embodiment, in this embodiment, the high-voltage sampling unit detects the voltage across the load capacitor. With the high-voltage sampling unit detecting the voltage across the load capacitor, the battery management system circuit can be controlled to start normal work when the voltage across the load capacitor reaches the preset voltage threshold.

A fifth embodiment of this application relates to a pre-charging method applied to the pre-charging circuit described in the first embodiment. FIG. 2 is a schematic diagram of the pre-charging circuit. The pre-charging method in this embodiment is intended to pre-charge the load capacitor in the battery management system circuit shown in FIG. 1. The battery management system circuit includes a battery pack V1, parasitic inductors L1 to L4, a positive main switch S1, a negative main switch S2, an anti-reverse switch S3, an X capacitor C1, protective capacitors C2 and C3, freewheeling diodes D1 and D2, and a load capacitor C4. Referring to FIG. 2, the pre-charging circuit includes: a controller 1, a PWM control unit 2, and a drive unit 3. The controller 1 and the PWM control unit 2 are connected to the drive unit 3. The drive unit 3 is connected to a main switch of the battery management system circuit. The main switch may be the positive main switch S1 or the negative main switch S2. In this embodiment and subsequent embodiments, an example is described in which the main switch is the positive main switch S1. In an example, the main switch is a semiconductor power switch, thereby reducing a failure rate of the main switch. The semiconductor power switch may be an IGBT or a MOSFET.

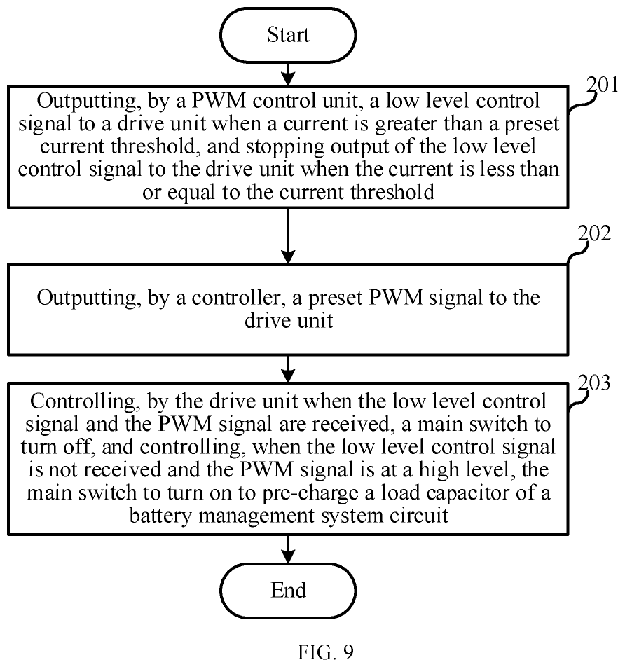

FIG. 8 shows a specific process of a pre-charging method according to this embodiment.

Step 101: A PWM control unit detects a current existent in a battery management system circuit when a main switch is turned on, and the PWM control unit outputs a control signal to a drive unit according to the current.

Specifically, the PWM control unit 2 can detect an instantaneous current generated in the battery management system circuit when the main switch in the battery management system circuit is turned on, and output a control signal to the drive unit 3 according to the instantaneous current.

Step 102: A controller outputs a preset PWM signal to the drive unit.

Specifically, in a pre-charging process of the load capacitor C4, the controller 1 continuously outputs the preset PWM signal to the drive unit 3. The PWM signal may be a signal with a fixed pulse width or a signal with a gradually varying pulse width.

Step 103: The drive unit controls, according to the received control signal and PWM signal, the main switch to turn off or on, so as to pre-charge a load capacitor of the battery management system circuit when the main switch is turned on.

Specifically, by outputting a control signal at an OUT end, the drive unit 3 controls, according to the control signal and the PWM signal that are coupled to an IN end of the drive unit, the main switch to turn off or on, so as to pre-charge the load capacitor C4 of the battery management system circuit when the main switch is turned on.

It needs to be noted that the controller 1 is also connected to a negative main switch S2 and an anti-reverse switch S3. Before the load capacitor C4 is pre-charged, the controller 1 outputs a continuous high level signal to the negative main switch S2 and the anti-reverse switch S3 to turn on the negative main switch S2 and the anti-reverse switch S3.

The first embodiment corresponds to this embodiment. Therefore, this embodiment may be implemented in collaboration with the first embodiment. The relevant technical details mentioned in the first embodiment are still applicable in this embodiment, and the technical effects achievable in the first embodiment can also be achieved in this embodiment. For brevity, details are omitted here. Correspondingly, the relevant technical details mentioned in this embodiment are also applicable in the first embodiment.

In contrast with the prior art, in this embodiment, the PWM control unit can detect the current existent in the battery management system circuit when the main switch of the battery management system circuit is turned on, and output the control signal to the drive unit according to the current. The controller outputs the preset PWM signal to the drive unit. According to the received control signal and PWM signal, the drive unit turns the main switch off or on. When the main switch is turned on, the load capacitor of the battery management system circuit can be pre-charged. In this application, the PWM control unit outputs the control signal to the drive unit, and the controller outputs the PWM signal to the drive unit, so that the drive unit can control on and off states of the main switch according to the control signal and the PWM signal to implement the pre-charging of the load capacitor. Compared with the conventional pre-charging circuit, this application reduces costs. In addition, the PWM signal output by the controller is used to adjust the pre-charging time of the load capacitor, so that the pre-charging time of the load capacitor of the battery management circuit can be adjusted according to needs, so as to achieve fast pre-charging.

A sixth embodiment of this application relates to a pre-charging method. This embodiment is substantially the same as the fifth embodiment, and primarily differs in: this embodiment provides a specific implementation of steps 101 to 103 described in the fifth embodiment.

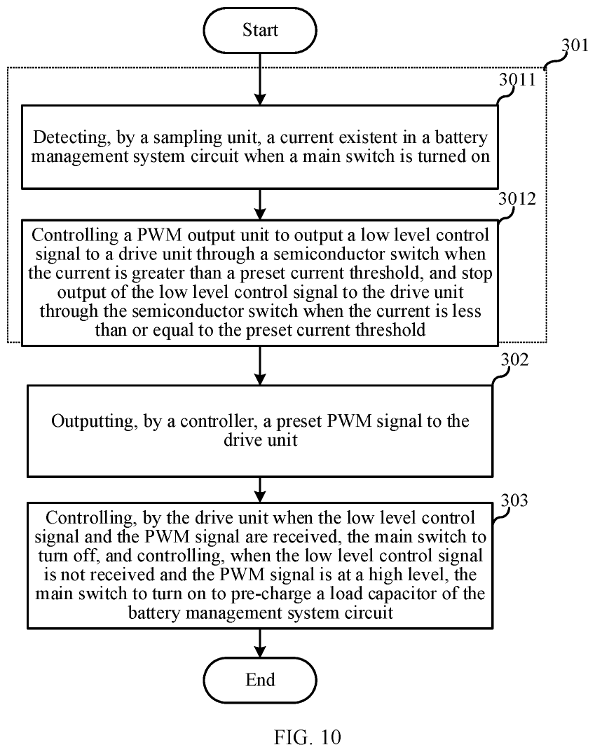

FIG. 9 shows a specific process of a pre-charging method according to this embodiment.

Step 201: A PWM control unit outputs a low level control signal to a drive unit when a current is greater than a preset current threshold, and stops output of the low level control signal to the drive unit when the current is less than or equal to the current threshold.

Step 202: A controller outputs a preset PWM signal to the drive unit.

Step 203: The drive unit controls, when the low level control signal and the PWM signal are received, a main switch to turn off, and controls, when the low level control signal is not received and the PWM signal is at a high level, the main switch to turn on to pre-charge a load capacitor of a battery management system circuit.

Specifically, in a case of a zero-state response, when the main switch in the battery management system circuit is turned on, a large instantaneous current is generated in the battery management system circuit. The battery management system circuit has a safe current value (that is, a preset current threshold).

If the PWM control unit 2 detects that the current in the battery management system circuit is greater than the preset current threshold when the main switch is turned on, the PWM control unit 2 outputs a low level control signal to the drive unit 3, and the controller 1 outputs the PWM signal to the drive unit 3. At this time, the PWM signal output by the controller 1 to the drive unit 3 is degraded by the low level control signal, the signal coupled to the IN end of the drive unit 3 is 0, the drive unit 3 controls the main switch to turn off, and the load capacitor C4 of the battery management system circuit is not pre-charged.

If the PWM control unit 2 detects that the current in the battery management system circuit is less than or equal to the preset current threshold when the main switch is turned on, the PWM control unit 2 stops outputting the low level control signal to the drive unit 3, and the controller 1 outputs the PWM signal to the drive unit 3. At this time, the input of the drive unit 3 is determined only by the PWM signal output by the controller 1. When the PWM signal is at a high level, the drive unit 3 controls the main switch to turn on to pre-charge the load capacitor C4 of the battery management system circuit. When the signal is at a low level, the drive unit 3 controls the main switch to turn off to stop pre-charging the load capacitor C4. When a next high level of the PWM signal comes, the above processes are repeated.

The second embodiment corresponds to this embodiment. Therefore, this embodiment may be implemented in collaboration with the second embodiment. The relevant technical details mentioned in the second embodiment are still applicable in this embodiment, and the technical effects achievable in the second embodiment can also be achieved in this embodiment. For brevity, details are omitted here. Correspondingly, the relevant technical details mentioned in this embodiment are also applicable in the second embodiment.

In contrast with the fifth embodiment, in this embodiment, if the current in the battery management system circuit is greater than the preset current threshold when the main switch is turned on, the PWM control unit outputs a low level control signal to the drive unit, and the controller outputs the PWM signal to the drive unit. At this time, a signal coupled to the drive unit is 0, and the drive unit controls the main switch to turn off. When the current is less than or equal to the current threshold, the PWM control unit stops outputting the low level control signal to the drive unit, and the controller outputs the PWM signal to the drive unit. At this time, the PWM signal controls the on and off states of the main switch. When the PWM signal is at a high level, the drive unit controls the main switch to turn on to implement pre-charging of the load capacitor, thereby pre-charging the load capacitor while protecting the battery management system circuit.

A seventh embodiment of this application relates to a pre-charging method. This embodiment is substantially the same as the fifth embodiment, and primarily differs in: this embodiment provides a specific implementation of detecting, by a PWM control unit, a current existent in a battery management system circuit when a main switch is turned on, and outputting a control signal to a drive unit according to the current.

The pre-charge method in this embodiment is applied to the pre-charging circuit in the third embodiment. FIG. 3 is a schematic diagram of the pre-charging circuit, and FIG. 4 shows the battery management system circuit.

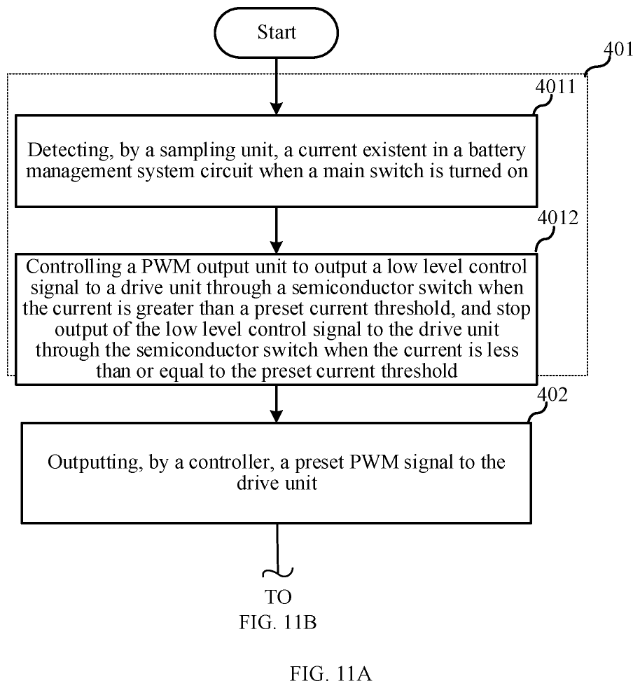

FIG. 10 shows a specific process of a pre-charging method according to this embodiment.

Step 301 includes the following substeps:

Substep 3011: A sampling unit detects a current existent in a battery management system circuit when a main switch is turned on.

Substep 3012: A PWM output unit is controlled to output a low level control signal to a drive unit through a semiconductor switch when the current is greater than a preset current threshold, and stop output of the low level control signal to the drive unit through the semiconductor switch when the current is less than or equal to the preset current threshold.

Step 302: A controller outputs a preset PWM signal to the drive unit.

Step 303: The drive unit controls, when the low level control signal and the PWM signal are received, the main switch to turn off, and controls, when the low level control signal is not received and the PWM signal is at a high level, the main switch to turn on to pre-charge a load capacitor of the battery management system circuit.

Specifically, referring to FIG. 5 and FIG. 6, during the pre-charging process, the controller 1 outputs a preset PWM signal to the drive unit, and a current limiting resistor R1 is generally serially connected between the controller 1 and the drive unit 3. The sampling unit 21 detects the current existent in the battery management system circuit when the main switch is turned on. If the current in the battery management system circuit is greater than the preset current threshold when the main switch is turned on, the PWM output unit 22 outputs a high level electrical signal to the semiconductor switch S4, and the semiconductor switch S4 is turned on to output a low level control signal to the drive unit 3. At this time, the PWM signal output by the controller 1 to the drive unit 3 is degraded by the low level control signal, the signal coupled to the IN end of the drive unit 3 is 0, the drive unit 3 controls the main switch to turn off, and the load capacitor C4 of the battery management system circuit is not pre-charged. If the current in the battery management system circuit is less than or equal to the preset current threshold when the main switch is turned on, the PWM output unit 22 outputs a low level electrical signal to the semiconductor switch S4, and the semiconductor switch S4 is cut off to stop outputting the low level control signal to the drive unit 3. At this time, the input of the drive unit 3 is determined only by the PWM signal output by the controller 1. When the PWM signal is at a high level, the drive unit 3 controls the main switch to turn on to pre-charge the load capacitor C4 of the battery management system circuit. When the signal is at a low level, the drive unit 3 controls the main switch to turn off to stop pre-charging the load capacitor C4. When a next high level of the PWM signal comes, the above processes are repeated.

The third embodiment corresponds to this embodiment. Therefore, this embodiment may be implemented in collaboration with the third embodiment. The relevant technical details mentioned in the third embodiment are still applicable in this embodiment, and the technical effects achievable in the third embodiment can also be achieved in this embodiment. For brevity, details are omitted here. Correspondingly, the relevant technical details mentioned in this embodiment are also applicable in the third embodiment.

In contrast with the sixth embodiment, this embodiment provides a specific implementation of detecting, by a PWM control unit, a current existent in a battery management system circuit when a main switch is turned on, and outputting a control signal to a drive unit according to the current.

An eighth embodiment of this application relates to a pre-charging method. This embodiment is an improvement based on the seventh embodiment. The improvement primarily lies in: determining, by detecting a voltage across a load capacitor, whether pre-charging of the load capacitor is completed.

The pre-charging method in this embodiment is applied to the pre-charging circuit described in the fourth embodiment. FIG. 6 is a schematic diagram of the pre-charging circuit.

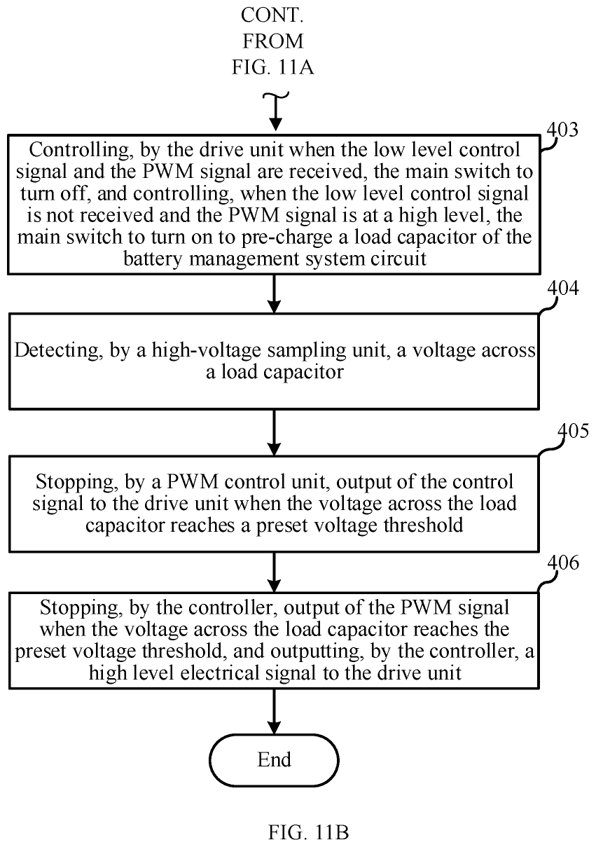

FIGS. 11A and 11B show a specific process of a pre-charging method according to this embodiment.

Steps 401 to 403 are substantially the same as steps 301 to 303, and details are omitted here. The main difference is that steps 404 to 406 are added, as detailed below:

Step 404: A high-voltage sampling unit detects a voltage across a load capacitor.

Step 405: A PWM control unit stops output of the control signal to the drive unit when the voltage across the load capacitor reaches a preset voltage threshold.

Step 406: A controller stops output of the PWM signal when the voltage across the load capacitor reaches the preset voltage threshold, and the controller outputs a high level electrical signal to the drive unit.

Specifically, the high-voltage sampling unit 4 can detect the voltage across the load capacitor C4. During the pre-charging process of the load capacitor C4, the voltage across the load capacitor C4 gradually increases, the instantaneous current generated by the battery management system circuit when the main switch is turned on gradually decreases, and the voltage across the load capacitor C4 is an instantaneous voltage value existent before the main switch is turned off. During the pre-charging process of the load capacitor C4, the voltage across the load capacitor C4 changes to

$${U}_{C 4} = {U}_{V 1} \times ( 1 - {e}^{- \frac{t}{τ}} ) ,$$

and the current of the battery management system circuit changes to

$$I = \frac{{U}_{V 1}}{R} \times {e}^{- \frac{t}{τ}} ,$$

where

$$τ = R \times C$$

$${u}_{C} = {U}_{bat} \times ( 1 - {e}^{- \frac{t}{τ}} ) ,$$

UV1 denotes a voltage of the battery pack V1, R is an equivalent impedance of the battery management system circuit, C is a capacitance value of the load capacitor C4, and t denotes a pre-charging time.

During the pre-charging process of the load capacitor C4, if the voltage UC4 across the load capacitor C4 reaches the preset voltage threshold, the pre-charging of the load capacitor C4 is completed, and the PWM output unit 22 of the PWM control unit 2 stops, through the semiconductor switch S4, outputting the low level control signal to the drive unit 3, and the controller 1 stops outputting the PWM signal and outputs a high level electrical signal to the drive unit 3. At this time, the drive unit 3 only receives the high level electrical signal output by the controller 1, the main switch is turned on, and the battery management system circuit starts to work normally. The voltage threshold is, for example, 95% of the voltage UV1 of the battery pack V1. That is, when it is detected that the voltage across the load capacitor C4 reaches 95% of the battery voltage UV1, the pre-charging for the load capacitor C4 stops.

The fourth embodiment corresponds to this embodiment. Therefore, this embodiment may be implemented in collaboration with the fourth embodiment. The relevant technical details mentioned in the fourth embodiment are still applicable in this embodiment, and the technical effects achievable in the fourth embodiment can also be achieved in this embodiment. For brevity, details are omitted here. Correspondingly, the relevant technical details mentioned in this embodiment are also applicable in the fourth embodiment.

In contrast with the seventh embodiment, in this embodiment, the high-voltage sampling unit detects the voltage across the load capacitor. With the high-voltage sampling unit detecting the voltage across the load capacitor, the battery management system circuit can be controlled to start normal work when the voltage across the load capacitor reaches the preset voltage threshold.

A person of ordinary skill in the art understands that the embodiments described above are exemplary embodiments for implementing this application. In practical applications, various modifications may be made in form and detail to the embodiments without departing from the spirit and scope of this application.

What is claimed is:

1. A pre-charging circuit, comprising: a controller, a pulse width modulation (PWM) control unit, and a drive unit, wherein the controller and the PWM control unit are electrically connected to the drive unit, and the drive unit is electrically connected to a main switch of a battery management system circuit;
the PWM control unit is configured to detect a current existent in the battery management system circuit when the main switch is turned on;
the PWM control unit is further configured to output a control signal to the drive unit according to the current existent in the battery management system circuit;
the controller is configured to output a preset PWM signal to the drive unit; and
the drive unit is configured to turn the main switch off or on according to the received control signal and PWM signal, so as to pre-charge a load capacitor of the battery management system circuit when the main switch is turned on.

2. The pre-charging circuit according to claim 1, wherein the PWM control unit is specifically configured to output a low level control signal to the drive unit when the current is greater than a preset current threshold, and stop output of the low level control signal to the drive unit when the current is less than or equal to the preset current threshold; and
the drive unit is specifically configured to turn the main switch off when the low level control signal and the PWM signal are received, and turn the main switch on when the low level control signal is not received and the PWM signal is at a high level to pre-charge the load capacitor of the battery management system circuit.

3. The pre-charging circuit according to claim 1, wherein the PWM control unit comprises a sampling unit, a PWM output unit, and a semiconductor switch that are connected in sequence, and the semiconductor switch is connected to the drive unit;
the sampling unit is configured to detect the current existent in the battery management system circuit when the main switch is turned on; and
the PWM output unit is configured to output the low level control signal to the drive unit through the semiconductor switch when the current is greater than a preset current threshold, and stop output of the low level control signal to the drive unit through the semiconductor switch when the current is less than or equal to the preset current threshold.

4. The pre-charging circuit according to claim 1, wherein the pre-charging circuit further comprises a high-voltage sampling unit electrically connected to the PWM control unit and the controller;
the high-voltage sampling unit is configured to detect a voltage across the load capacitor;
the PWM control unit is further configured to stop output of the control signal to the drive unit when the voltage across the load capacitor reaches a preset voltage threshold; and
the controller is configured to stop output of the PWM signal when the voltage across the load capacitor reaches the preset voltage threshold, and output a high level electrical signal to the drive unit.

5. The pre-charging circuit according to claim 3, wherein the sampling unit is specifically configured to collect a voltage across a current divider in the battery management system circuit, and calculate the current according to a resistance value of the current divider and the voltage across the current divider.

6. The pre-charging circuit according to claim 3, wherein the PWM output unit is specifically configured to output a high level electrical signal to turn on the semiconductor switch when the current is greater than a preset current threshold, so as to output the low level control signal to the drive unit; and
the PWM output unit is specifically configured to output a low level electrical signal to turn off the semiconductor switch when the current is less than or equal to the preset current threshold, so as to stop output of the low level control signal to the drive unit.

7. The pre-charging circuit according to claim 1, wherein the main switch is a semiconductor power switch.

8. The pre-charging circuit according to claim 7, wherein the semiconductor power switch is an insulated gate bipolar transistor (IGBT) or a metal oxide semiconductor field effect transistor (MOSFET).

9. A pre-charging method, applied to a pre-charging circuit, wherein: the pre-charging circuit comprises a controller, a PWM control unit, and a drive unit, the controller and the PWM control unit are connected to the drive unit, and the drive unit is connected to a main switch of a battery management system circuit;
the method comprises:
detecting, by the PWM control unit, a current existent in the battery management system circuit when the main switch is turned on;
outputting, by the PWM control unit, a control signal to the drive unit according to the current;
outputting, by the controller, a preset PWM signal to the drive unit; and
controlling, by the drive unit according to the received control signal and PWM signal, the main switch to turn off or on, so as to pre-charge a load capacitor of the battery management system circuit when the main switch is turned on.

10. The pre-charging method according to claim 9, wherein the outputting, by the PWM control unit, a control signal to the drive unit according to the current further includes:
outputting, by the PWM control unit, a low level control signal to the drive unit when the current is greater than a preset current threshold, and stopping output of the low level control signal to the drive unit when the current is less than or equal to the current threshold; and
the controlling, by the drive unit according to the received control signal and PWM signal, the main switch to turn off or on, so as to pre-charge a load capacitor of the battery management system circuit when the main switch is turned on further includes:
turning, by the drive unit, the main switch off when the low level control signal and the PWM signal are received; and
turning, by the drive unit, the main switch on when the low level control signal is not received and the PWM signal is at a high level so as to pre-charge the load capacitor of the battery management system circuit.

11. The pre-charging method according to claim 9, wherein the PWM control unit comprises a sampling unit, a PWM output unit, and a semiconductor switch that are connected in sequence, and the semiconductor switch is connected to the drive unit; and
the detecting, by the PWM control unit, a current existent in the battery management system circuit when the main switch is turned on, and outputting, by the PWM control unit, a control signal to the drive unit according to the current further comprises:
detecting, by the sampling unit, the current existent in the battery management system circuit when the main switch is turned on; and
controlling the PWM output unit to output the low level control signal to the drive unit through the semiconductor switch when the current is greater than a preset current threshold; and
controlling the PWM output unit to stop output of the low level control signal to the drive unit through the semiconductor switch when the current is less than or equal to the preset current threshold.

12. The pre-charging method according to claim 9, wherein the pre-charging circuit further comprises a high-voltage sampling unit connected to the PWM control unit and the controller; and
the method further comprises:
detecting, by the high-voltage sampling unit, a voltage across the load capacitor;
stopping, by the PWM control unit, output of the control signal to the drive unit when the voltage across the load capacitor reaches a preset voltage threshold; and
stopping, by the controller, output of the PWM signal when the voltage across the load capacitor reaches the preset voltage threshold, and outputting, by the controller, a high level electrical signal to the drive unit.
